(19) United States
(12) Patent Application Publication
(10) Pub. No.: US 2019/0011735 A1
(43) Pub. Date: Jan. 10, 2019

(54) Display Panel and Display Device

(71) Applicant: BOE TECHNOLOGY GROUP CO., LTD., Beijing (CN)

(72) Inventors: Jifeng TAN, Beijing (CN); Wei WANG, Beijing (CN); Yafeng YANG, Beijing (CN); Xiaochuan CHEN, Beijing (CN); Pengxia LIANG, Beijing (CN); Dacheng ZHANG, Beijing (CN)

(21) Appl. No.: 15/749,258

(22) PCT Filed: Jul. 31, 2017
(86) PCT No.: PCT/CN2017/095232

§ 371 Date: Jan. 31, 2018

(30) Foreign Application Priority Data
Oct. 28, 2016 (CN) 201610963912.8

(51) Int. Cl. G02F 1/1334; G02F 1/1335; G02F 1/1343; G02F 1/29; C09K 19/54

(52) U.S. Cl. CPC G02F 1/1334; G02F 1/133524; G02F 1/133528; G02F 1/29; C09K 19/544; G02F 1/1343

(57) ABSTRACT

A display panel and a display device are disclosed. The display panel comprises a first substrate, a second substrate, a gating layer, and a waveguide layer, a first electrode and a second electrode between the first and the second substrates, the gating layer includes a polymer layer and multiple liquid crystal gratings arranged with an interval, the polymer layer covering the liquid crystal gratings and being in gaps between the liquid crystal gratings. The first and second electrodes are configured to adjust a refractive index of the liquid crystal gratings by changing voltages applied thereto, a coupling efficiency at which light is coupled out of the waveguide layer is determined according to difference between the refractive indices of the liquid crystal gratings and the polymer layer, and the grating layer controls exiting angle and diffraction efficiency of light of a specific color in each pixel unit.

### CROSS-REFERENCE TO RELATED APPLICATIONS

This is a National Phase Application filed under 35 U.S.C. 371 as a national stage of PCT/CN2017/095232, filed Jul. 31, 2017, an application claiming the benefit of Chinese Application No. 201610963912.8, filed Oct. 28, 2016, the content of each of which is hereby incorporated by reference in its entirety.

### TECHNICAL FIELD

The present disclosure relates to the field of display technology, and particularly relates to a display panel and a display device.

### BACKGROUND

In the field of display technology, a liquid crystal display device includes a backlight and a display panel. The display panel includes an array substrate and a color filter substrate provided opposite to each other, a liquid crystal layer is provided between the array substrate and the color filter substrate, and the array substrate and the color filter substrate each are provided with a polarizer on the back. Grayscale display is achieved through deflection of liquid crystals controlled by a voltage and control of the two polarizers.

In the prior art, color resistors in the color filter substrate may be made of a resin material doped with a dye.

The use of a polarizer in a display panel of a liquid crystal display device in the prior art may result in a low transmittance of the liquid crystal display device (for example, a transmittance of about 7%) and a large liquid crystal cell thickness (for example, 3 μm to 5 μm), and a large cell thickness may reduce response speed of liquid crystal. Due to poor filtering effect of a dye itself in the prior art, the color resistors made of a resin doped with the dye will render a liquid crystal display device with a low transmittance.

### SUMMARY

The present disclosure provides a display panel including a first substrate, a second substrate, a gating layer, a waveguide layer, a first electrode and a second electrode, the gating layer, the waveguide layer, the first electrode and the second electrode are located between the first substrate and the second substrate, the gating layer includes a polymer layer, and a plurality of liquid crystal gratings arranged with an interval therebetween, and the polymer layer covers the liquid crystal gratings and is also located in gaps between the plurality of liquid crystal gratings.

Optionally, the first electrode and the second electrode are configured to adjust a refractive index of the liquid crystal gratings; and

the liquid crystal grating are configured to control light to be coupled out of the waveguide layer and control light having a specific wavelength among the light coupled out of the waveguide layer to be emitted out in a specific direction, and a coupling efficiency at which light is coupled out of the waveguide layer is determined according to a difference between the refractive index of the liquid crystal gratings and a refractive index of the polymer layer.

Optionally, the second electrode is on a side of the second substrate proximal to the first substrate, the waveguide layer is on a side of the second electrode proximal to the first substrate, the liquid crystal gratings are on a side of the waveguide layer proximal to the first substrate, the polymer layer is on a side of the liquid crystal gratings proximal to the first substrate, and the first electrode is on a side of the first substrate proximal to the second substrate.

Optionally, the second electrode is on a side of the second substrate proximal to the first substrate, the first electrode is on a side of the second electrode proximal to the first substrate, the waveguide layer is on a side of the first electrode proximal to the first substrate, the liquid crystal gratings are on a side of the waveguide layer proximal to the first substrate, and the polymer layer is on a side of the liquid crystal gratings proximal to the first substrate.

Optionally, the refractive index of the polymer layer ranges from an ordinary refractive index n₀ of the liquid crystal gratings to an extraordinary refractive index nₑ of the liquid crystal gratings.

Optionally, the refractive index of the polymer layer is the ordinary refractive index n₀ of the liquid crystal gratings.

Optionally, a material of the grating layer is a polymer dispersed liquid crystal.

Optionally, in a case where the difference between the refractive index of the liquid crystal gratings and the refractive index of the polymer layer is zero, the coupling efficiency at which light is coupled out of the waveguide layer is zero, so that the display panel is in L0 grayscale state; or

in a case where an absolute value of the difference between the refractive index of the liquid crystal gratings and the refractive index of the polymer layer is equal to a set value, the coupling efficiency at which light is coupled out of the waveguide layer is a set coupling efficiency, so that the display panel is in L255 grayscale state; or

in a case where the absolute value of the difference between the refractive index of the liquid crystal gratings and the refractive index of the polymer layer is larger than zero and smaller than the set value, the coupling efficiency at which light is coupled out of the waveguide layer is larger than zero and smaller than the set coupling efficiency, so that the display panel is in a grayscale state other than the L0 grayscale state and L255 grayscale state.

Optionally, the display panel includes a plurality of pixel units, each of the plurality of pixel units includes a plurality of liquid crystal gratings, and the liquid crystal gratings in each pixel unit are configured to cause light having the specific wavelength among the light coupled out of the waveguide layer to be emitted out in a specific diffraction angle, wherein the specific diffraction angle is determined by a grating period of the liquid crystal gratings in each pixel unit.

Optionally, a zero-order diffraction intensity and a first-order diffraction intensity of the liquid crystal gratings in each pixel unit are determined according to a thickness and/or duty ratio of the liquid crystal gratings.

The present disclosure further provides a display device, including a backlight and the above display panel.

### BRIEF DESCRIPTION OF THE DRAWINGS

FIG. 1 is a schematic structural diagram of a display panel according to a first embodiment of the present disclosure;

FIG. 2 is a schematic diagram of a waveguide layer in FIG. 1;

FIG. 3 is a diagram of an optical path of the waveguide layer in FIG. 2;

FIG. 4 is a schematic diagram illustrating diffraction principle of liquid crystal gratings in FIG. 1;

FIG. 5 is a schematic diagram illustrating interference principle of liquid crystal gratings in FIG. 1;

FIG. 6 is a schematic structural diagram of a display panel according to a second embodiment of the present disclosure;

FIG. 7 is a schematic structural diagram of a display device according to a third embodiment of the present disclosure;

FIG. 8 is a diagram of an optical path of the display device in FIG. 7;

FIG. 9a is a schematic diagram of a display device, which adopts the display panel in FIG. 1, in a display mode;

FIG. 9b is a schematic diagram of a display device, which adopts the display panel in FIG. 1, in another display mode;

FIG. 10a is a schematic diagram of a display device, which adopts the display panel in FIG. 4, in a display mode; and

FIG. 10b is a schematic diagram of a display device, which adopts the display panel in FIG. 4, in another display mode.

### DETAILED DESCRIPTION

To enable those skilled in the art to better understand technical solutions of the present disclosure, a display panel and a display device provided in the present disclosure will be described in detail below in conjunction with the accompanying drawings.

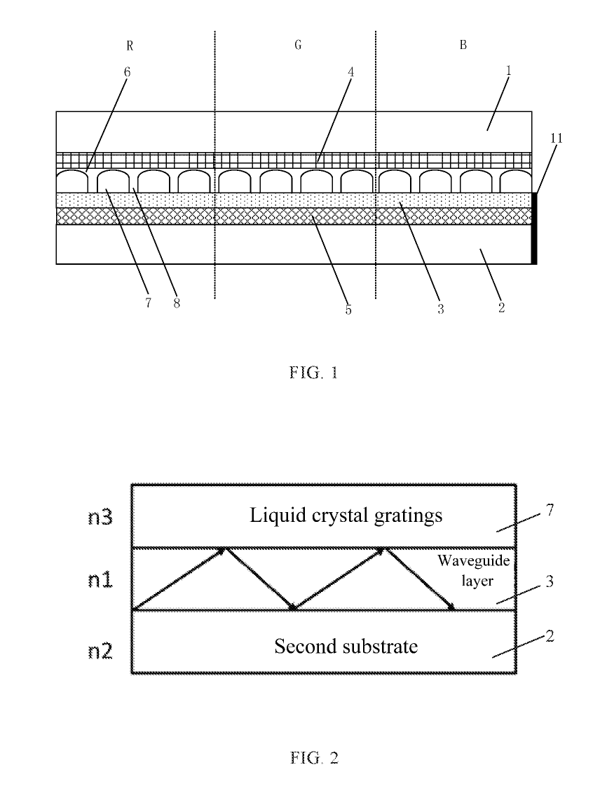

FIG. 1 is a schematic structural diagram of a display panel according to a first embodiment of the present disclosure. As shown in FIG. 1, the display panel includes a first substrate 1, a second substrate 2, a gating layer, a waveguide layer 3, a first electrode 4 and a second electrode 5, and the gating layer, the waveguide layer 3, the first electrode 4 and the second electrode 5 are positioned between the first substrate 1 and the second substrate 2. The gating layer includes a polymer layer 6, and a plurality of liquid crystal gratings 7 arranged with an interval therebetween, and the polymer layer 6 covers the liquid crystal gratings 7 and is also positioned in gaps 8 between the plurality of liquid crystal gratings 7. A refractive index of the liquid crystal gratings 7 may be adjusted by changing voltages applied on the first electrode 4 and the second electrode 5. The liquid crystal gratings 7 are configured to control light to be coupled out of the waveguide layer 3 and control light having a specific wavelength among the light coupled out of the waveguide layer 3 to be emitted out in a specific direction, wherein a coupling efficiency at which light is coupled out of the waveguide layer 3 is determined according to a difference between the refractive index of the liquid crystal gratings 7 and a refractive index of the polymer layer 6.

In the embodiment, the coupling efficiency at which light is coupled out of the waveguide layer 3 changes as the difference between the refractive index of the liquid crystal gratings 7 and the refractive index of the polymer layer 6 changes. Since the refractive index of the liquid crystal gratings 7 can be adjusted according to a voltage difference between the voltages applied to the first electrode 4 and the second electrode 5, the refractive index of the liquid crystal gratings 7 changes when the difference between the voltages applied to the first electrode 4 and the second electrode 5 changes, and accordingly the difference between the refractive index of the liquid crystal gratings 7 and the refractive index of the polymer layer 6 changes as well, so that the coupling efficiency at which light is coupled out of the waveguide layer 3 changes.

The first substrate 1 may be made of glass or a resin, and the second substrate 2 may be made of glass or a resin. In practical applications, the first substrate 1 and the second substrate 2 may be made of other material, which is not listed herein one by one.

In the embodiment, the first electrode 4 and the second electrode 5 may be located on one side or on different sides of the grating layer. Optionally, the first electrode 4 may be a common electrode and the second electrode 5 may be a pixel electrode.

As shown in FIG. 1, the first electrode 4 and the second electrode 5 are located on different sides of the grating layer. Specifically, the second electrode 5 is on a side of the second substrate 2 proximal to the first substrate 1, the waveguide layer 3 is on a side of the second electrode 5 proximal to the first substrate 1, the liquid crystal gratings 7 are on a side of the waveguide layer 3 proximal to the first substrate 1, the polymer layer 6 is on a side of the liquid crystal gratings 7 proximal to the first substrate 1, and the first electrode 4 is on a side of the first substrate 1 proximal to the second substrate 2.

A material of the grating layer is a polymer dispersed liquid crystal (PDLC). The grating layer is made of a material that can be obtained as follows: liquid crystal molecules are mixed with a polymer material, to form micron-sized liquid crystal droplets by a polymerization reaction under certain conditions, and the micron-sized liquid crystal droplets are uniformly dispersed in a high polymer network, and then a material having photoelectric response properties is obtained using dielectric anisotropy of the liquid crystal molecules. PDLC is a mixture, and the grating layer obtained through the polymerization reaction includes grating structures 7 proximal to the waveguide layer 3 and the polymer layer 6 proximal to the first electrode 4. Material of the grating structures 7 is liquid crystal molecules or liquid crystal molecules mixed with a part of the polymer material. In practical manufacturing process, the liquid crystal molecules forming the grating structures 7 may be mixed with a part of the polymer material due to limitation of the process level, however, the material of the grating structures 7 is preferably liquid crystal molecules without polymer material, that is, the material of the grating structures 7 is liquid crystal molecules only.

The refractive index nₚ of the polymer layer 6 ranges from an ordinary refractive index n₀ of the liquid crystal gratings 7 to an extraordinary refractive index nₑ of the liquid crystal gratings 7. Preferably, the refractive index nₚ of the polymer layer 6 is the ordinary refractive index n₀ of the liquid crystal gratings 7. In the absence of an applied voltage, a regular electric field cannot be formed, optical axes of the liquid crystal molecules are orientated randomly and disorderedly, the effective refractive index n₀ of the liquid crystal molecules does not match with the refractive index nₚ of the polymer layer 6, and in this case, the effective refractive index n₀ of the grating layer is an intermediate value between n₀ and nₑ. In the presence of an applied voltage, the optical axes of the liquid crystal molecules are aligned perpendicular to a film surface, that is, in the same direction as that of the electric field, the ordinary refractive index n₀ of the liquid crystal molecules substantially matches with the refractive index nₚ of the polymer layer 6, thus, there is no obvious interface between the liquid crystal gratings 7 and the polymer layer 6, forming a substantially uniform medium, and in this case, the overall refractive index of the grating layer is n₀.

The waveguide layer 3 may be made of a transparent material, for example, silicon nitride Si₃N₄. The waveguide layer 3 has a thickness in the range of, but not limited to, 10 nm to 10 μm, and preferably, the thickness of the waveguide layer 3 is 100 nm, so as to facilitate control of the grating layer on light exiting direction and wavelength. Generally, the waveguide layer 3 is a single mode waveguide, that is, its thickness should be thin enough, but in a case where light from an edge type collimated backlight has good collimation or mode to be coupled into the waveguide layer 3 can be effectively controlled, the requirement on the thickness of the waveguide layer 3 may be relaxed. For example, the thickness of the waveguide layer 3 may be set to be several hundred nanometers or even several micrometers. Because the thickness of the waveguide layer 3 is much smaller than the thickness of the second electrode 7 and the thickness of the waveguide layer 3 is much smaller than the thickness of the second substrate 2, most of light emitted by the edge type collimated backlight will be coupled into the second electrode 5 and the second substrate 2. Since the light emitted by the edge type collimated backlight cannot be absolutely collimated, there is always a small divergence angle, and thus light coupled into the second electrode 5 and the second substrate 2 also has a small divergence angle. The refractive index of the waveguide layer 3 needs to be greater than a refractive index of one or more layers adjacent to the waveguide layer 3 to ensure that light is totally reflected in the waveguide layer 3. Since the refractive index of the second electrode 5 is smaller than the refractive index of the waveguide layer 3 and the refractive index of the second substrate 2 is smaller than the refractive index of the waveguide layer 3, light in the second electrode 5 and the second substrate 2 cannot be well confined, and is injected into the waveguide layer 3 to compensate for attenuation of the waveguide mode of the waveguide layer 3 due to propagation or coupling of the grating layer. In summary, the second electrode 5 and the second substrate 2 function as an auxiliary waveguide.

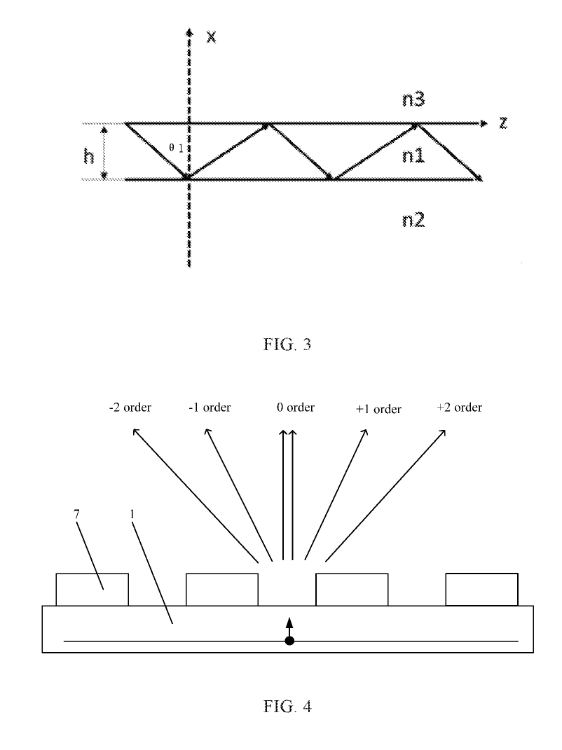

FIG. 2 is a schematic diagram of a waveguide layer in FIG. 1, FIG. 3 is a diagram of an optical path of the waveguide layer in FIG. 2, and it needs to be noted that the second electrode is not shown in FIG. 2. As shown in FIGS. 2 and 3, the second substrate 2, the waveguide layer 3 and the liquid crystal gratings 7 form a planar waveguide, the refractive index of the second substrate 2 is n₂, the refractive index of the waveguide layer 3 is n₁ and the refractive index of the liquid crystal gratings 7 is n₃. The thickness of the waveguide layer 3 is typically micron-sized, and can be comparable to the wavelength of light. A difference between refractive indices of the waveguide layer 3 and the second substrate 2 may be between 10⁻¹ and 10⁻³. In order to form a true optical waveguide, n₁ must be greater than n₂ and n₃, that is, n₁>n₂≥n₃, and in this way, light can be limited to propagate in the waveguide layer 3. Propagation of light in a planar waveguide can be considered as that light is totally reflected at an interface between the waveguide layer 3 and the second substrate 2 and at an interface between the waveguide layer 3 and the liquid crystal gratings 7, and propagates along a zigzag path in the waveguide layer 3. Light propagates in a zigzag pattern in the Z direction in the waveguide layer 3. In the planar waveguide, n₁>n₂ and n₁>n₃, when an incident angle θ₁ of incident light exceeds the critical angle θ₀:

$$sin {θ}_{0} = \frac{{n}_{2}}{{n}_{1}}$$

the incident light is totally reflected, and at this point, a certain phase jump is produced at the reflection point. From Fresnel reflection formula:

$${R}_{TE} = \frac{{n}_{1} cos {θ}_{1} - \sqrt{{n}_{2}^{2} - {n}_{1}^{2} {sin}^{2} {θ}_{1}}}{{n}_{1} cos {θ}_{1} + \sqrt{{n}_{2}^{2} - {n}_{1}^{2} {sin}^{2} {θ}_{1}}} ;$$

$${R}_{TM} = \frac{{n}_{2}^{2} cos {θ}_{1} - {n}_{1} \sqrt{{n}_{2}^{2} - {n}_{1}^{2} {sin}^{2} {θ}_{1}}}{{n}_{2}^{2} cos {θ}_{1} + {n}_{1} \sqrt{{n}_{2}^{2} - {n}_{1}^{2} {sin}^{2} {θ}_{1}}} ,$$

it can be derived that the phase jumps ϕ_{TM}, ϕ_{TE} at the reflection point are:

$$tan {φ}_{TE} = \frac{\sqrt{{β}^{2} - {k}_{0}^{2} {n}_{2}^{2}}}{\sqrt{{k}_{0}^{2} {n}_{1}^{2} - {β}^{2}}} ;$$

$$tan {φ}_{TM} = \frac{{n}_{1}^{2} \sqrt{{β}^{2} - {k}_{0}^{2} {n}_{2}^{2}}}{{n}_{2}^{2} \sqrt{{k}_{0}^{2} {n}_{1}^{2} - {β}^{2}}} ;$$

where β=k₀n₁ sin θ₁, β is a propagation constant of light, k₀=2π/λ, k₀ is a wave number of light in vacuum, and λ is the wavelength of light. In order for light to propagate stably in the waveguide layer 3, the following equation needs to be satisfied:

2kh−2ϕ₁₂−2ϕ₁₃=2mπ,m=0,1,2,3 . . . ;

where k=k₀n₁ cos θ, ϕ₁₂ and ϕ₁₃ are phase differences of total reflection, h is the thickness of the waveguide layer 3, m is a mode order, that is, a positive integer starting from zero. Therefore, only light having an incident angle satisfying the above equation can stably propagate in the optical waveguide, and the above equation is a dispersion equation for a planar waveguide.

Further, the display panel further includes a black shielding layer 11 on a side of the waveguide layer 3 for absorbing light emitted out from the side of the waveguide layer 3. Alternatively, the display panel may further include a reflective layer on a side of the waveguide layer 3 for reflecting light emitted out from the side of the waveguide layer 3.

Further, the display panel further includes gate lines, data lines and thin film transistors. For example, the gate lines, the data lines and the thin film transistors may be located between the second electrode 5 and the second base substrate 2. Each thin film transistor includes a gate, an active layer, a source and a drain, and the second electrode 5 is connected to the drain of the thin film transistor. The gate lines, the data lines and the thin film transistors are not shown in FIG. 1.

The refractive index nₚ of the polymer layer 6 ranges from an ordinary refractive index n₀ of the liquid crystal gratings 7 to an extraordinary refractive index nₑ of the liquid crystal gratings 7. Preferably, the refractive index nₚ of the polymer layer 6 is the ordinary refractive index n₀ of the liquid crystal gratings 7. In the embodiment, the refractive index of the liquid crystal gratings 7 is adjusted by adjusting the difference between the voltages applied to the first electrode 4 and the second electrode 5 to change orientations of liquid crystal molecules in the liquid crystal gratings 7, so that the refractive index of the liquid crystal gratings 7 is adjusted between n₀ and nₑ. As the refractive index of the liquid crystal gratings 7 changes, the difference between the refractive index of the liquid crystal gratings 7 and the refractive index of the polymer layer 6 changes, and therefore, the coupling efficiency at which light is coupled out of the waveguide layer 3 is controlled by controlling the difference between the refractive index of the liquid crystal gratings 7 and the refractive index of the polymer layer 6, thereby obtaining a desired display grayscale in each pixel.

When the difference between the refractive index of the liquid crystal gratings 7 and the refractive index of the polymer layer 6 is zero, the coupling efficiency at which light is coupled out of the waveguide layer 3 is zero, so that the display panel is in L0 grayscale state. The function of the liquid crystal gratings 7 is disabled, and no light is coupled out of the waveguide layer 3, and in this case, the display panel is in L0 grayscale state.

When an absolute value of the difference between the refractive index of the liquid crystal gratings 7 and the refractive index of the polymer layer 6 is a set difference, the coupling efficiency at which light is coupled out of the waveguide layer 3 is a set coupling efficiency, so that the display panel is in L255 grayscale state. In this case, because the absolute value of the difference between the refractive index of the liquid crystal gratings 7 and the refractive index of the polymer layer 6 is the set difference, and the refractive index of the polymer layer 6 is fixed, the refractive index of the liquid crystal gratings 7 can be adjusted between the ordinary refractive index n₀ and the extraordinary refractive index nₑ such that the absolute value of the difference between the adjusted refractive index of the liquid crystal gratings 7 and the refractive index of the polymer layer 6 is a maximum value, and in this case, the set difference is the maximum difference, the corresponding set coupling efficiency is the maximum coupling efficiency, the liquid crystal gratings 7 have the maximum effect, the coupling efficiency at which light is coupled out from the waveguide layer 3 is the highest, and at this point, the display panel is in L255 grayscale state.

When the absolute value of the difference between the refractive index of the liquid crystal gratings 7 and the refractive index of the polymer layer 6 is larger than zero but smaller than the set difference, the coupling efficiency at which light is coupled out of the waveguide layer 3 is larger than zero but smaller that the set coupling efficiency, so that the display panel is in an intermediate grayscale state between the L0 grayscale state and the L255 grayscale state. In this case, the coupling efficiency is between zero and the maximum coupling efficiency, so that the display panel is in another grayscale state. By adjusting the difference between the refractive index of the liquid crystal gratings 7 and the refractive index of the polymer layer 6, the display panel can be in different grayscale states.

It should be noted that: the term “grayscale” means that brightness between the brightest and the darkest is divided into a plurality of levels, levels of different brightness from the darkest to the brightest are represented by grayscales, and more levels means more delicate picture effect that can be presented. 256 grayscales can display 256 levels of brightness and may include 256 grayscale levels from L0 grayscale to L255 grayscale.

In this embodiment, the display panel includes a plurality of pixel units, and each of the plurality of pixel units includes a plurality of liquid crystal gratings 7. The liquid crystal gratings 7 in each pixel unit are configured to make light having a specific wavelength among light coupled out of the waveguide layer 3 to be emitted out at a specific diffraction angle, and the specific diffraction angle is determined by the grating period of the gratings 7 in each pixel unit. As shown in FIG. 1, the pixel unit may be a red pixel unit R, a green pixel unit G, or a blue pixel unit B, and the plurality of pixel units included in the display panel are red pixel units R, green pixel units G and blue pixel units B arranged sequentially. For a red pixel unit R, light having a specific wavelength to be displayed is red light, light coupled out of the waveguide layer 3 is irradiated onto the liquid crystal gratings 7 in the red pixel unit R, the grating period of the liquid crystal gratings 7 in the red pixel unit R determines a red light diffraction angle, and red light can be emitted out at the red light diffraction angle and enters into human eyes, whereas light having other wavelengths emitted out at other diffraction angles, for example, green light and blue light, will not be irradiated into human eyes, so that the red pixel unit R appears red. For a green pixel unit G, light having a specific wavelength to be displayed is green light, light coupled out of the waveguide layer 3 is irradiated onto the liquid crystal gratings 7 in the green pixel unit G, the grating period of the liquid crystal gratings 7 in the green pixel unit G determines a green light diffraction angle, and green light can be emitted out at the green light diffraction angle and enters into human eyes, whereas light having other wavelengths emitted out at other diffraction angles, for example, red light and blue light, will not be irradiated into human eyes, so that the green pixel unit G appears green. For a blue pixel unit B, light having a specific wavelength to be displayed is blue light, light coupled out of the waveguide layer 3 is irradiated onto the liquid crystal gratings 7 in the blue pixel unit B, the grating period of the liquid crystal gratings 7 in the blue pixel unit B determines a blue light diffraction angle, and blue light can be emitted out at the blue light diffraction angle and enters into human eyes, whereas light having other wavelengths emitted out at other diffraction angles, for example, red light and green light, will not be irradiated into human eyes, so that the blue pixel unit B appears blue.

As shown in FIG. 1, the waveguide layer 3, the liquid crystal gratings 7 and the polymer layer 6 form a variable grating coupler, and the phase matching of the variable grating coupler is as follows:

2π/λ×Nm=2π/λ×nₚ sin θ+q2π/Λ (q=0, ±1, ±2, . . . ),

Where λ is the specific wavelength, Nm is an effective refractive index of the m-th order guided mode, nₚ is the refractive index of the polymer layer 6, θ is the specific diffraction angle, q is the diffraction order, and Λ is the grating period of the liquid crystal gratings 7. It can be seen from the above formula that it is possible for light having a specific wavelength, among emitted light, to be emitted at a specific diffraction angle, by adjusting the grating period Λ of the liquid crystal gratings 7. The specific diffraction angle is an angle between a light exiting direction of emergent light and a plane normal line. Description is given by taking a red pixel unit R in FIG. 1 as an example, the red pixel unit R needs to emit red light, that is, the specific wavelength of the emergent light is the wavelength of red light, thus, by determining the grating period Λ of the liquid crystal gratings 7 in the red pixel unit R, red light can be emitted out at the specific diffraction angle θ (i.e., the red light diffraction angle) under the premise that the specific wavelength λ of the emergent light is the wavelength of red light. Similarly, by determining the grating period Λ of the liquid crystal gratings 7 in a green pixel unit G, green light can be emitted out at the specific diffraction angle θ (i.e., the green light diffraction angle) under the premise that the specific wavelength λ of the emergent light is the wavelength of green light; by determining the grating period Λ of the liquid crystal gratings 7 in a blue pixel unit B, blue light can be emitted out at the specific diffraction angle θ (i.e., the blue light diffraction angle) under the premise that the specific wavelength λ of the emergent light is the wavelength of blue light. The grating period of the liquid crystal gratings 7 in each pixel unit is determined by the number of the liquid crystal gratings 7 in each pixel unit 7. For example, the number of the liquid crystal gratings 7 in a red pixel unit R may range from 5 to 10, the number of the liquid crystal gratings 7 in a green pixel unit G may range from 4 to 8, and the number of the liquid crystal gratings 7 in a blue pixel unit B may range from 3 to 5. It should be noted that, the number of the liquid crystal gratings 7 in each pixel unit as shown in FIG. 1 only indicates that each pixel unit includes a plurality of liquid crystal gratings, but does not indicate the actual number of the liquid crystal gratings 7 in each pixel unit.

In the embodiment, by way of coherent light interference, different regions of the mixture of the liquid crystal molecules and the polymer are respectively irradiated with a laser, so as to form the liquid crystal gratings 7 in different pixel units. For example, red laser light emitted by a red laser irradiates on the region corresponding to a red pixel unit R through a exposure grating, so as to form the liquid crystal gratings 7 in the red pixel unit R, green laser light emitted by a green laser irradiates on the region corresponding to a green pixel unit G through a exposure grating, so as to form the liquid crystal gratings 7 in the green pixel unit G, and blue laser light emitted by a blue laser irradiates on the region corresponding to a blue pixel unit B through a exposure grating, so as to form the liquid crystal gratings 7 in the blue pixel unit B. Since lasers of different colors emit exposure light having different wavelengths, different numbers of liquid crystal gratings 7 are formed in the pixel units of different colors, so that the liquid crystal gratings 7 formed in different pixel units of different colors have different grating periods A. It can be known from the formula:

$$Λ = \frac{{λ}_{b}}{2 sin ( \frac{{θ}_{b}}{2} )}$$

that in a case where exposure light emitted by the lasers of different colors has a same incident angle θ_{b}, a different wavelengths λ_{b} of exposure light result in different grating periods Λ of the formed liquid crystal gratings 7.

A zero-order diffraction intensity and a first-order diffraction intensity of the liquid crystal gratings 7 in each pixel unit are determined according to a thickness and/or a duty ratio of the liquid crystal gratings 7. FIG. 4 is a schematic diagram illustrating diffraction principle of the liquid crystal gratings in FIG. 1, and FIG. 5 is a schematic diagram illustrating interference principle of liquid crystal gratings in FIG. 1. As shown in FIG. 4, light irradiated onto the liquid crystal gratings 7 undergoes multi-order diffraction, and zero-order diffraction (0-order), first-order diffraction (+1 order, −1 order) and second-order diffraction (+2 order, −2 order) are shown in FIG. 5. As shown in FIG. 5, light irradiated onto the liquid crystal gratings 7 also undergoes interference, and the interference may include destructive interference or constructive interference. In a case where the interference is destructive interference, h1 (n4−n5)=mλ/2, where h1 is the thickness of the liquid crystal gratings 7, n4 is the refractive index of the liquid crystal gratings 7, n5 is the refractive index of the polymer layer 6, and λ is the wavelength of light. For example, when n4=1.8 and n5=1.3, λ=h1/m, and when m=1, 3, 5, . . . , a transmission valley appears at the zero-order diffraction and a transmission peak appears at the first-order diffraction. In a case where the interference is constructive interference, h1 (n4−n5)=mλ, where h1 is the thickness of the liquid crystal gratings 7, n4 is the refractive index of the liquid crystal gratings 7, n5 is the refractive index of the polymer layer 6, and λ is the wavelength of light. For example, when n4=1.8 and n5=1.3, λ=h1/2m, and when m=1, 2, 3, . . . , a transmission peak appears at the zero-order diffraction and a transmission valley appears at the first-order diffraction. In the embodiment, a case where a transmission valley occurs at the zero-order diffraction and a transmission peak occurs at the first-order diffraction when m=1, 3, 5, . . . , is adopted. Since white light is emitted out through the zero-order diffraction, white light cannot be transmitted through the zero-order diffraction of the grating structures 7 when a transmission valley occurs at the zero-order diffraction, so that the white light is filtered out. Since light having a specific wavelength is emitted out through the first-order diffraction of the grating structures 7, when a transmission peak occurs at the first-order diffraction, light having the specific wavelength can be emitted out through the first-order diffraction of the grating structures 7. It can be seen from the formula of destructive interference and constructive interference that the zero-order diffraction intensity and the first-order diffraction intensity of the liquid crystal gratings 7 can be adjusted by adjusting the thickness h1 of the liquid crystal gratings 7 in each pixel unit. Alternatively, the zero-order diffraction intensity and the first-order diffraction intensity of the liquid crystal gratings 7 can be adjusted by adjusting the duty ratio of the liquid crystal gratings 7 in each pixel unit, and the duty ratio is the ratio of a grating width W of the liquid crystal gratings 7 to the grating period Λ of the liquid crystal gratings 7. Alternatively, the zero-order diffraction intensity and the first-order diffraction intensity of the liquid crystal gratings 7 may be adjusted by adjusting the thickness h1 and the duty ratio of the liquid crystal gratings 7 in each pixel unit. By selectively setting the zero-order diffraction intensity and the first-order diffraction intensity for light of a specific color, diffraction efficiency of light having a specific wavelength can be adjusted, so as to change the diffraction efficiency (or light output ratio) of the light of a specific color coupled out of the waveguide layer.

The display panel of the embodiment includes a first substrate, a second substrate, a grating layer, a waveguide layer, a first electrode and a second electrode, the grating layer includes a polymer layer and liquid crystal gratings, the first electrode and the second electrode can adjust the refractive index of the liquid crystal gratings, the liquid crystal gratings control light to be coupled out of the waveguide layer and control light having a specific wavelength, among the light coupled out of the waveguide layer, to be emitted out in a specific direction, and the coupling efficiency at which light is coupled out of the waveguide layer is determined according to a difference between the refractive index of the liquid crystal gratings and the refractive index of the polymer layer. In the embodiment, there is no need to provide a polarizer and color resistors in the display panel, thereby improving the transmittance of the display panel. In the embodiment, since there is no need to provide a polarizer in the display panel, there is no requirement on amount of phase retardation of the entire liquid crystal layer, so that a liquid crystal cell may be set to have a smaller thickness, thereby improving response time of the liquid crystal. In the embodiment, the PDLC itself has a property of quick response, thereby further improving the response time of the liquid crystal. Since the display panel of the embodiment has high transmittance, the display panel can be applied to a transparent display product, a virtual reality (VR) product, or an augmented reality (AR) product. In the embodiment, the grating layer adopts a PDLC material, and no alignment layer is required, so that the process is simplified. In the embodiment, the grating period of the liquid crystal gratings is small, and therefore, each pixel unit may be made small, so that the display panel can achieve high PPI display.

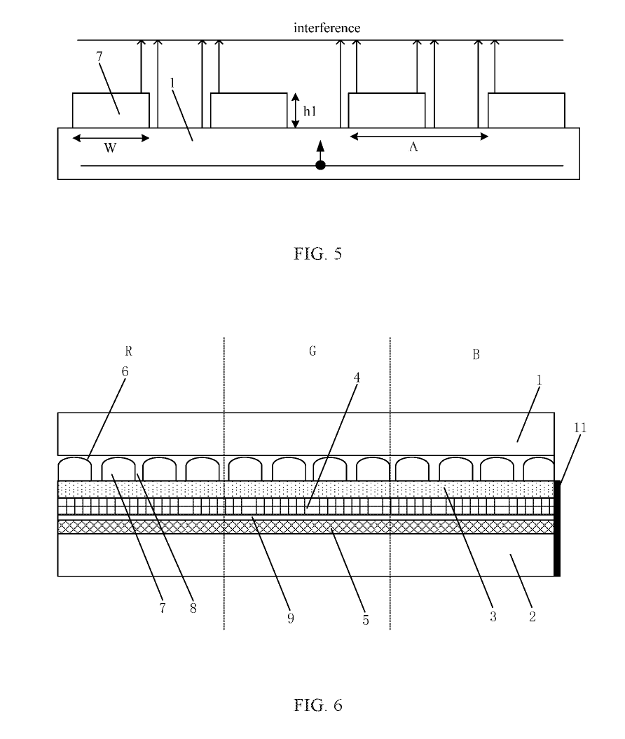

FIG. 6 is a schematic structural diagram of a display panel according to a second embodiment of the present disclosure. As shown in FIG. 6, this embodiment differs from the first embodiment in that, the second electrode 5 is on a side of the second substrate 2 proximal to the first substrate 1, the first electrode 4 is on a side of the second electrode 5 proximal to the first substrate 1, the waveguide layer 3 is on a side of the first electrode 4 proximal to the first substrate 1, the liquid crystal gratings 7 are on a side of the waveguide layer 3 proximal to the first substrate 1, and the polymer layer 6 is on a side of the liquid crystal gratings 7 proximal to the first substrate 1.

Further, an insulating layer 9 is provided between the first electrode 4 and the second electrode 5.

Descriptions of the other structures in the embodiment may refer to those in the first embodiment, and are not repeated herein.

The display panel of the embodiment includes a first substrate, a second substrate, a grating layer, a waveguide layer, a first electrode and a second electrode, the grating layer includes a polymer layer and liquid crystal gratings, the first electrode and the second electrode are configured to adjust the refractive index of the liquid crystal gratings by changing voltages applied thereto, the coupling efficiency at which light is coupled out of the waveguide layer is determined according to a difference between the refractive index of the liquid crystal gratings and the refractive index of the polymer layer, and the grating layer controls the exiting angle and diffraction efficiency of light of a specific color in each pixel unit. In the embodiment, there is no need to provide a polarizer and color resistors in the display panel, and thus the transmittance of the display panel is improved. In the embodiment, since there is no need to provide a polarizer in the display panel, there is no requirement on amount of phase retardation of the entire liquid crystal layer, so that a liquid crystal cell may be set to have a small thickness, thereby improving response time of the liquid crystal. In the embodiment, the PDLC itself has a property of quick response, thereby further improving the response time of the liquid crystal. Since the display panel of the embodiment has high transmittance, the display panel can be applied to a transparent display product, a virtual reality (VR) product, or an augmented reality (AR) product. In the embodiment, the grating layer adopts a PDLC material, and no alignment layer is required, so that the process is simplified. In the embodiment, the grating period of the liquid crystal gratings is small, and therefore, each pixel unit may be made small, so that the display panel can achieve high PPI display.

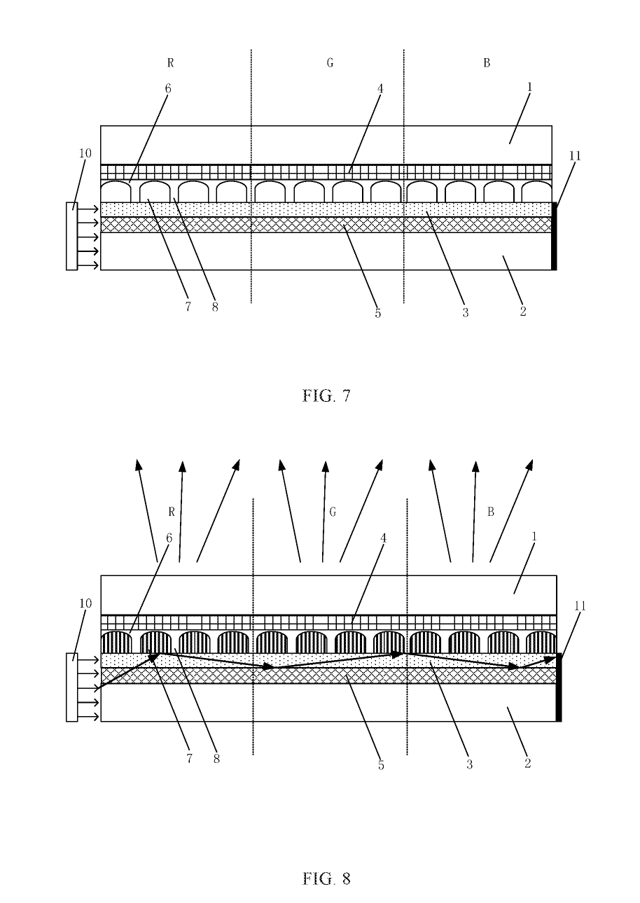

FIG. 7 is a schematic structural diagram of a display device according to a third embodiment of the present disclosure. As shown in FIG. 7, the display device includes a backlight 10 and the display panel.

In the embodiment, the backlight 10 is arranged at a side of the display panel, and therefore, the backlight in the embodiment is an edge type backlight. In practical applications, a backlight in other form may also be used. For example, the backlight may be a direct type backlight, which is not specifically illustrated.

The backlight 10 may include an LED light source or a light source of another form. The LED light source may include a white LED or a light source formed by combining a red LED, a green LED and a blue LED. The light source in another form may be a laser light source, and the laser light source may be a light source formed by combining a red laser light source, a green laser light source and a blue laser light source. The light source in another form may include a CCFL lamp and a light collimation structure. Optionally, in a case where the backlight 10 is a laser light source, a beam expanding structure may be further provided on a light exiting side of the backlight 10 (i.e., between the backlight 10 and the display panel), and the beam expanding structure can not only expand laser light, as a laser point light source, emitted by the laser light source into a collimated light source, but also increase a diameter of a light beam.

The backlight 10 is provided at least correspondingly to the waveguide layer 3, and a light exiting direction of light from the backlight 10 is parallel to a plane where the waveguide layer 3 is located. As shown in FIG. 7, the backlight 10 is provided correspondingly to the second substrate 2, the waveguide layer 3 and the second electrode 5, and a width of the backlight 10 may be the sum of widths of the second substrate 2, the waveguide layer 3 and the second electrode 5. In practical applications, the backlight 10 may be set to have other width, but it is preferable that the backlight 10 does not emit light towards the grating layer and layers above the grating layer. Since a sealant is provided on outer side of the grating layer, light emitted towards the grating layer will not enter into the liquid crystal gratings 7 in the grating layer.

Preferably, light emitted from the backlight 10 is collimated light. In particular, when the backlight 10 is a laser light source, light emitted from the backlight 10 becomes collimated light due to the beam expanding structure. In the embodiment, light emitted from the backlight 10 may be white light.

FIG. 8 is a schematic diagram of an optical path of the display device in FIG. 7. As shown in FIG. 8, light emitted by the backlight 10 enters into the waveguide layer 3, and is totally reflected in the waveguide layer 3, so as to propagate along a zigzag path in the waveguide layer 3. The liquid crystal gratings 7 control light to be coupled out of the waveguide layer 3 and control light having a specific wavelength among the light coupled out of the waveguide layer 3 to be emitted out in a specific direction, so that light of different colors is emitted out from pixel units of different colors.

The display device of the embodiment employs the display panel shown in FIG. 1, the detailed description of which may refer to that in the first embodiment and is not repeated herein.

The display device of the embodiment may also employ the display panel shown in FIG. 6, the detailed description of which may refer to that in the second embodiment and is not repeated herein.

In this embodiment, the display device may be an ECB display device, a TN display device, a VA display device, an IPS display device, or an ADS display device.

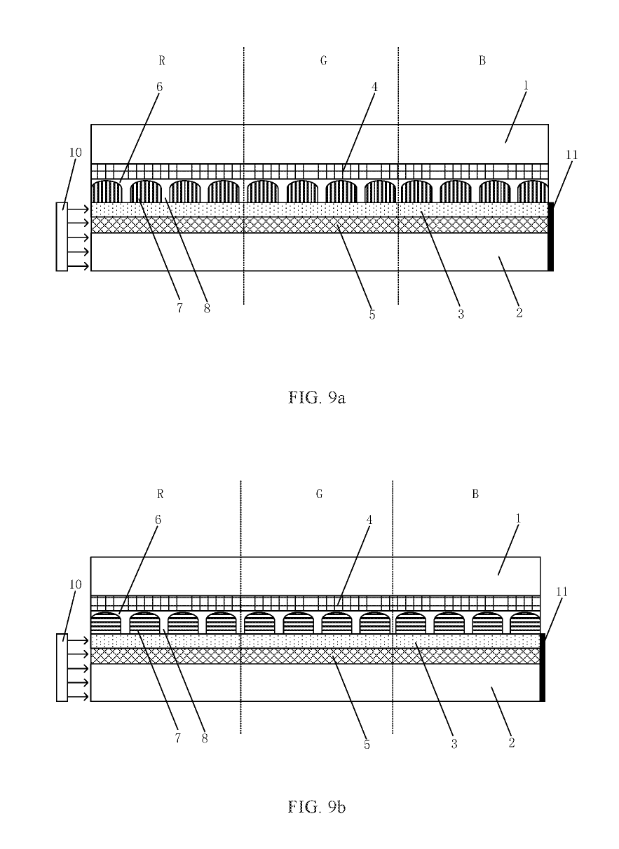

FIG. 9a is a schematic diagram of a display device, which adopts the display panel in FIG. 1, in a display mode, and FIG. 9b is a schematic diagram of a display device, which adopts the display panel in FIG. 1, in another display mode. As shown in FIG. 9a, the difference between the voltages applied to the first electrode 4 and the second electrode 5 is adjusted to adjust orientations of liquid crystal molecules in the liquid crystal gratings 7 such that the refractive index of the liquid crystal gratings 7 is equal to the refractive index of the polymer layer 6, so the difference between the refractive index of the liquid crystal gratings 7 and the refractive index of the polymer layer 6 is zero, in this case, the coupling efficiency at which light is coupled out of the waveguide layer 3 is zero, and thus the display device is in L0 grayscale state. As shown in FIG. 9b, the difference between the voltages applied to the first electrode 4 and the second electrode 5 is adjusted to adjust orientations of liquid crystal molecules in the liquid crystal gratings 7 such that the absolute value of the difference between the refractive index of the liquid crystal gratings 7 and the refractive index of the polymer layer 6 is the set difference, which is the maximum difference, in this case, the coupling efficiency at which light is coupled out of the waveguide layer 3 is the set coupling efficiency, which is the maximum coupling efficiency, thus the display panel is in L255 grayscale state. It should be noted that the patterns in the grating structures 7 in FIGS. 9a and 9b merely indicate that liquid crystal molecules in the two figures are orientated differently but not intended to limit the orientations of the liquid crystal molecules.

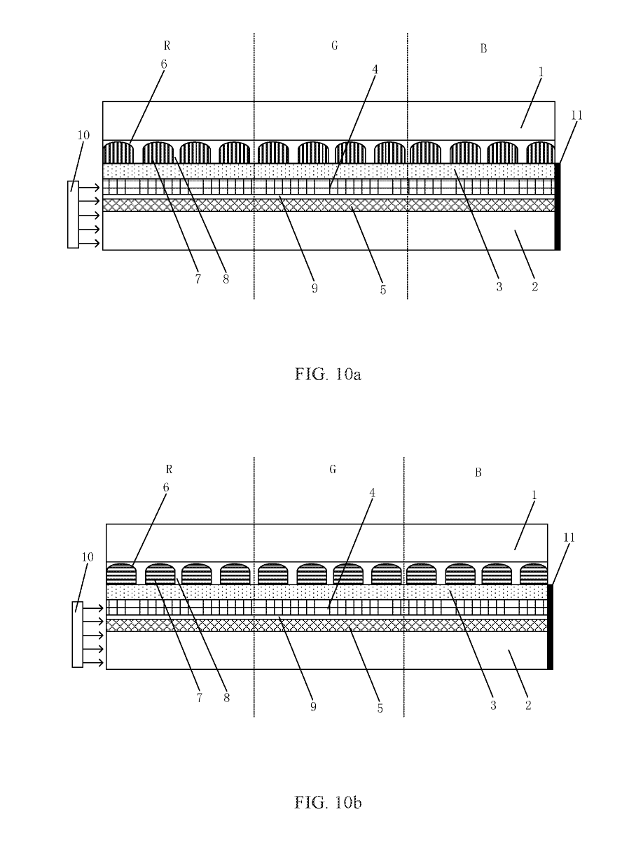

FIG. 10a is a schematic diagram of a display device, which adopts the display panel in FIG. 4, in a display mode, and FIG. 10b is a schematic diagram of a display device, which adopts the display panel in FIG. 4, in another display mode. As shown in FIG. 10a, the difference between the voltages applied to the first electrode 4 and the second electrode 5 is adjusted to adjust orientations of liquid crystal molecules in the liquid crystal gratings 7 such that the refractive index of the liquid crystal gratings 7 is equal to the refractive index of the polymer layer 6, so the difference between the refractive index of the liquid crystal gratings 7 and the refractive index of the polymer layer 6 is zero, in this case, the coupling efficiency at which light is coupled out of the waveguide layer 3 is zero, and thus the display device is in L0 grayscale state. As shown in FIG. 10b, the difference between the voltages applied to the first electrode 4 and the second electrode 5 is adjusted to adjust orientations of liquid crystal molecules in the liquid crystal gratings 7 such that the absolute value of the difference between the refractive index of the liquid crystal gratings 7 and the refractive index of the polymer layer 6 is the set difference, which is the maximum difference, in this case, the coupling efficiency at which light is coupled out of the waveguide layer 3 is the set coupling efficiency, which is the maximum coupling efficiency, thus the display panel is in L255 grayscale state. It should be noted that the patterns in the grating structures 7 in FIGS. 10a and 10b merely indicate that liquid crystal molecules in the two figures are orientated differently but not intended to limit the orientations of the liquid crystal molecules.

Since only e-polarized light whose vibration direction is in the principal plane (the cross section as shown in figures) can be influenced by the change in the refractive index of the liquid crystal gratings 7, whereas o-polarized light whose vibration direction is perpendicular to the principal plane cannot be influenced by the change in the refractive index of the liquid crystal gratings 7, the light coupled out of the waveguide layer 3 is e-polarized light, and the coupling efficiency of the e-polarized light can be controlled by controlling orientations of liquid crystal molecules in the grating structures 7, thereby implementing grayscale display.

Due to the scattering characteristics of PDLC, the display device of the present disclosure is suitable for realizing a variable grating by using the change in the refractive index of the liquid crystal, and light is coupled out of the waveguide layer by the variable grating to achieve grayscale display. PDLC can diffuse the coupled light, so that the display device can achieve normal display.

In the display device provided in the embodiment, the display panel includes a first substrate, a second substrate, a grating layer, a waveguide layer, a first electrode and a second electrode, the grating layer includes a polymer layer and liquid crystal gratings, the first electrode and the second electrode are configured to adjust the refractive index of the liquid crystal gratings by changing voltages applied thereto, the coupling efficiency at which light is coupled out of the waveguide layer is determined according to a difference between the refractive index of the liquid crystal gratings and the refractive index of the polymer layer, and the grating layer controls the exiting angle and diffraction efficiency of light of a specific color in each pixel unit. In the embodiment, there is no need to provide a polarizer and color resistors in the display panel, and thus the transmittance of the display panel is improved. In the embodiment, since there is no need to provide a polarizer in the display panel, there is no requirement on amount of phase retardation of the entire liquid crystal layer, so that a liquid crystal cell may be set to have a small thickness, thereby improving response time of the liquid crystal. In the embodiment, the PDLC itself has quick response property, thereby further improving the response time of the liquid crystal. Since the display panel of the embodiment has high transmittance, the display panel can be applied to a transparent display product, a virtual reality (VR) product, or an augmented reality (AR) product. In the embodiment, the grating layer adopts a PDLC material, and no alignment layer is required, so that the process is simplified. In the embodiment, the grating period of the liquid crystal gratings is small, and therefore, each pixel unit may be made small, so that the display panel can achieve high PPI display.

It could be understood that the above embodiments are merely exemplary embodiments adopted for describing the principle of the present invention, but the present invention is not limited thereto. Various variations and improvements may be made by those of ordinary skill in the art without departing from the spirit and essence of the present invention, and these variations and improvements shall also be regarded as falling into the protection scope of the present invention.

1-10. (canceled)

11. A display panel, comprising a first substrate, a second substrate, a gating layer, a waveguide layer, a first electrode and a second electrode, wherein the gating layer, the waveguide layer, the first electrode and the second electrode are located between the first substrate and the second substrate, the gating layer comprises: a polymer layer; and a plurality of liquid crystal gratings arranged with an interval therebetween, and the polymer layer covers the liquid crystal gratings and also is located in gaps between the plurality of liquid crystal gratings;
the first electrode and the second electrode are configured to adjust a refractive index of the liquid crystal gratings by changing voltages applied thereto;
wherein a coupling efficiency at which light is coupled out of the waveguide layer is determined according to a difference between the refractive index of the liquid crystal gratings and a refractive index of the polymer layer.

12. The display panel of claim 11, wherein the second electrode is on a side of the second substrate proximal to the first substrate, the waveguide layer is on a side of the second electrode proximal to the first substrate, the liquid crystal gratings are on a side of the waveguide layer proximal to the first substrate, the polymer layer is on a side of the liquid crystal gratings proximal to the first substrate, and the first electrode is on a side of the first substrate proximal to the second substrate.

13. The display panel of claim 11, wherein the second electrode is on a side of the second substrate proximal to the first substrate, the first electrode is on a side of the second electrode proximal to the first substrate, the waveguide layer is on a side of the first electrode proximal to the first substrate, the liquid crystal gratings are on a side of the waveguide layer proximal to the first substrate, and the polymer layer is on a side of the liquid crystal gratings proximal to the first substrate.

14. The display panel of claim 11, wherein the refractive index of the polymer layer ranges from an ordinary refractive index n₀ of the liquid crystal gratings to an extraordinary refractive index nₑ of the liquid crystal gratings.

15. The display panel of claim 14, wherein the refractive index of the polymer layer is the ordinary refractive index n₀ of the liquid crystal gratings.

16. The display panel of claim 11, wherein a material of the grating layer is a polymer dispersed liquid crystal.

17. The display panel of claim 11, wherein in a case where the difference between the refractive index of the liquid crystal gratings and the refractive index of the polymer layer is zero, the coupling efficiency at which light is coupled out of the waveguide layer is zero, so that the display panel is in L0 grayscale state.

18. The display panel of claim 11, wherein in a case where an absolute value of the difference between the refractive index of the liquid crystal gratings and the refractive index of the polymer layer is equal to a set value, the coupling efficiency at which light is coupled out of the waveguide layer is a set coupling efficiency, so that the display panel is in L255 grayscale state.

19. The display panel of claim 11, wherein in a case where an absolute value of the difference between the refractive index of the liquid crystal gratings and the refractive index of the polymer layer is larger than zero and smaller than a set value, the coupling efficiency at which light is coupled out of the waveguide layer is larger than zero and smaller than a set coupling efficiency, so that the display panel is in a grayscale state other than L0 grayscale state and L255 grayscale state.

20. The display panel of claim 11, further comprising a plurality of pixel units, wherein each of the plurality of pixel units comprises a plurality of liquid crystal gratings, and a grating period of the liquid crystal gratings in each pixel unit corresponds to an exiting angle of light having a specific wavelength.

21. The display panel of claim 20, wherein a zero-order diffraction intensity and a first-order diffraction intensity of the liquid crystal gratings in each pixel unit are determined according to a thickness and/or duty ratio of the liquid crystal gratings.

22. A display device, comprising a backlight and the display panel of claim 11.

23. A display device, comprising a backlight and the display panel of claim 12.
